(19) United States
(12) Patent Application Publication
(10) Pub. No.: US 2015/0175776 A1
(43) Pub. Date: Jun. 25, 2015

(54) METHOD FOR STABILIZING POLYMERS CONTAINING ESTER GROUPS

(71) Applicant: Rhein Chemie Rheinau GmbH, Mannehim (DE)

(72) Inventors: Wilhelm Laufer, Ellerstadt (DE); Armin Eckert, Oberhausen-Rheinhausen (DE)

(21) Appl. No.: 14/405,573

(22) PCT Filed: Mar. 22, 2013
(86) PCT No.: PCT/EP2013/056158

§ 371 Date: Dec. 4, 2014

(30) Foreign Application Priority Data
Jun. 5, 2012 (EP) 12170771.5

(51) Int. Cl. C08K 5/29

(52) U.S. Cl. CPC C08K 5/29

(57) ABSTRACT

The invention relates to methods for stabilizing polymers containing ester groups, in which specific monomeric aromatic carbodiimides are added in liquid-dosed form in the course of preparation thereof and/or processing thereof.

The invention relates to methods for stabilizing polymers containing ester groups, in which monomeric aromatic carbodiimides are added in liquid-dosed form in the course of preparation and/or processing thereof.

Carbodiimides have been found to be useful in many applications, for example as hydrolysis stabilizers for thermoplastics, polyols, polyurethanes, etc.

Preference is given to using sterically hindered carbodiimides for this purpose. A carbodiimide that is particularly well known in this connection is 2,6-dlisopropylphenylcarbodiimide (Stabaxol® from Rhein Chemie Rheinau GmbH).

The carbodiimides known in the prior art for this purpose, however, have the disadvantages of being volatile even at low temperatures. They are thermally unstable and exhibit a significant tendency to blocking in powder form. Used as a stabilizer in polymeric systems, they have the disadvantage that they are not free-flowing, and so first have to be melted prior to application and can only then be metered in.

There is therefore a need for sterically hindered carbodiimides which are usable for this purpose and which do not have the aforementioned disadvantages.

It was therefore an object of the present invention to provide a method for stabilizing polymers containing ester groups, wherein the stabilizers are thermally stable and storage-stable, are present as a mobile liquid even at room temperature, are easily preparable and can be applied in liquid form.

This object was surprisingly achieved by the use of particular monomeric carbodiimides.

The present invention therefore provides a method for stabilizing polymers containing ester groups, in which carbodiimides of the formula (I)

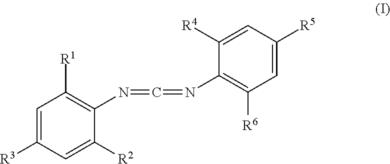

in which R¹, R², R⁴ and R⁶ is each independently C₃-C₆-alkyl
and R³ and R⁵ is each independently C₁-C₃-alkyl, are added in liquid-dosed form an continuous or batchwise processes for preparation and/or processing thereof.

The C₃-C₆-alkyl radicals may be linear and/or branched. They are preferably branched.

In the carbodiimides of the formula (I) used in the process according to the invention, the R¹ to R⁶ radicals are preferably the same.

In a further preferred embodiment of the invention, the R¹ to R⁶ radicals are isopropyl.

The carbodiimides are liquid at room temperature and preferably have viscosities at 25° C. of less than 2000 mPas, more preferably of less than 1000 mPas.

The scope of the invention includes all general radical definitions, indices, parameters and illustrations mentioned above and below, and those mentioned in preferred ranges with one another, i.e. also arty combinations between the respective ranges and preferred ranges.

The compounds of the formula (I) are storage-stable and liquid at room temperature, and feature excellent meterability.

These carbodiimides are preparable by the carbodiimidization of

trisubstituted benzene isocyanates of the formula (II)

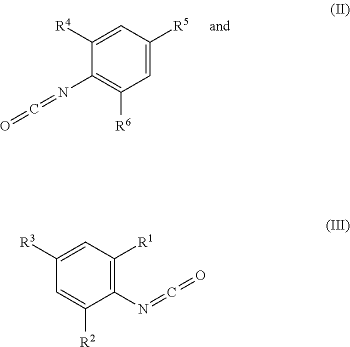

in which R¹, R², R⁴ and R is each independently C₃-C₆-alkyl
and R³ and R⁵ is each independently C₁-C₃-alkyl,
with elimination of carbon dioxide at temperatures of 40° C. to 200° C. in the presence of catalysts and optionally solvents.

The trisubstituted benzene isocyanates are preferably 2,4,6-triisopropylphenyl isocyanate, 2,6-diisopropyl-4-ethylphenyl isocyanate and 2,6-diisopropyl-4-methylphenyl isocyanate. The trisubstituted benzene amines needed for the preparation thereof can as is known to those skilled in the art be prepared by a Friedel-Crafts alkylation of aniline with the appropriate alkene, haloalkane, haloalkenebenzene and/or halocycloalkane.

Subsequently, they are reacted with phosgene to give the corresponding trisubstituted benzene isocyanate.

The carbodiimidization is preferably effected by the methods described in Angew. Chem. 93, p. 855-866 (1981) or DE-A-11 30 594 or Tetrahedron Letters 48 (2007), p. 6002-6004.

Preferred catalysts for the preparation of the compounds of the formula (I), in one embodiment of the invention, are strong bases or phosphorus compounds. Preference is given to using phospholene oxides, phospholidines or phospholine oxides, and the corresponding sulfides. It is also possible to use, as catalysts, tertiary amines, basic metal compounds, alkali metal or alkaline earth metal oxides or hydroxides, alkoxides or phenoxides, metal carboxylates and non-basic organometallic compounds.

The carbodiimidization can be performed either in substance or in a solvent. It is likewise possible first to commence the carbodiimidization in substance and subsequently to complete it after addition of a solvent. Solvents used may, for example, be benzines, benzene and/or alkylbenzenes.

Preferably, the carbodiimides for use in the process according to the invention are purified before they are used. The crude products can be purified either by distillation or by means of extraction. Suitable solvents used for the purification may, for example, be alcohols, ketones, ethers or esters.

It is also likewise possible to prepare the carbodiimides for use in the process according to the invention from the trisubstituted anilines by reaction with CS₂ to give the thiourea derivative and subsequent reaction in basic hypochlorite solutions to give the carbodiimide or by the methods described in EP 0597382A.

The liquid dosage in the process according to the invention is effected batchwise or continuously, preferably in continuous processing machines, for example single-shaft, grin-shaft and multi-shaft extruders, continuous co-kneaders (Buss type) and/or batchwise kneaders, for example Banbury type, and other units customary in the polymer industry. This can be effected right at the start of or in the course of preparation of the polymer containing ester groups, or right at the start of or in the course of processing, for example to give monofilaments, or to give polymer pellets.

“Liquid-dosed” in the context of the invention is understood to mean that the aforementioned carbodiimides of the formula (I) are metered in liquid form, by gravimetric or volumetric means, into the continuous or batchwise processing machines. In order to enable this, the inventive carbodiimides must be liquid and of low viscosity on dosage thereof, especially at ambient temperature, as is customary in polymer processing. For liquid dosage in processing operations, the continuous dosage units customary in thermoplastic compounding technology are used. These may be heatable. They are preferably not heatable.

It is also likewise possible to use liquid mixtures of carbodiimides of the formula (I) in combination with other sterically demanding polymeric and/or monomeric carbodiimides, for example polymeric carbodiimide based on tetramethylxylylene diisocyanate and/or bis(2,6-diisopropylphenyl)carbodiimide.

The term “continuous process” in the context of the invention means that all the formulation constituents, including the liquid carbodiimide, have the proportion by mass prescribed in the formulation at any juncture in the metered addition and processing.

The term “batchwise process” in the context of the invention means that all the formulation constituents, including the liquid carbodiimide, have the proportion by mass prescribed in the formulation at the end of the metered addition.

The proportion by mass of the carbodiimide depends on the later use and is preferably 0.1 to 5% by weight, more preferably 0.5 to 3% by weight, most preferably 1-2% by weight.

The liquid dosage of the carbodiimide is effected preferably at temperatures of 5 to 120° C., more preferably at 5 to 40° C., more preferably at 10 to 35° C.

The polymers containing ester groups are preferably thermoplastic polyurethanes (TPU).

These are commercial products which can be obtained, for example, from Bayer MaterialScience AG.

Examples for the preparation of polymers containing ester groups and processing thereof preferably include thermoplastic polyurethanes (TPU) and PU elastomers. The term “PU elastomer” includes hot-cast and cold-cast elastomers based on polyurethane. TPU, and also PU elastomers, are prepared by polyaddition during processing. For this purpose, all the raw materials and additives in liquid and/or solid form are fed simultaneously to the compounding extruder in a continuous manner, or batchwise in a stirred reactor. In the compounding extruder, the mixing and polyaddition proceed to give the finished, polymeric, additized thermoplastic, TPU.

Preference is further given to TPU which is only stabilized on completion of polyaddition, by continuous metered addition of the liquid carbodiimides into the molten TPU in the compounding extruder by means of continuous metering units.

The examples which follow serve to illustrate the invention but have no limiting effect.

### WORKING EXAMPLES

A liquid polymeric carbodiimide based on tetramethylxylylene diisocyanate available under the Stabaxol® P 200 name and a monomeric carbodiimide (bis(2,6-diisopropylphenyl)carbodiimide), available under the Stabaxol® I name from Rhein Chemie Rheinau GmbH, was tested in comparison with the inventive liquid monomeric carbodiimide (CDI I) of the formula

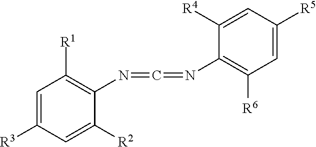

where the R¹ to R⁶ radicals are isopropyl,
in polyester polyol of the Desmophen® 2001 KS type from Bayer MaterialScience AG.
Preparation of the Carbodiimide Used in Accordance with the Invention

A baked-out and nitrogen-filled 500 ml flange vessel was initially charged under a nitrogen stream with 400 g of 2,4,6-triisopropylphenyl isocyanate and heated to 140° C. After adding 400 mg of 1-methylphospholene oxide, the reaction mixture was heated to 160° C. within 5 hours. Thereafter, reaction was continued at 160° C. until an NCO content of <1% (corresponding to >95% conversion) had been attained. The crude product thus obtained was purified by means of distillation. The product obtained was a pale yellow liquid having the viscosity of 700 mPas at 25° C.

### Thermal Stability

To study the thermal stability, thermogravimetry analyses were conducted with a TGA analysis unit from Mettler Toledo (TGA851). For this purpose, 10-15 mg in each case of samples were analyzed under nitrogen with a temperature ramp from 30 to 600° C. at a heating rate of 10° C./min. The temperature in ° C. on attainment of a weight loss of 5% was assessed [T(5%)].

The results are shown in Table 1:

| Carbodiimide | T(5%) of carbodiimide [° C.] |
|---|---|
| Stabaxol ™ I (C) | 200 |
| Stabaxol ™ P 200 (C) | 270 |
| CDI I (inv.) | 260 |

C = comparative example, inv. = inventive

### Acid Number Decrease in Polyester Polyol

As is known, the effect of a hydrolysis stabilizer based on sterically hindered carbodiimides in liquid polyester polyols can be tested by means of acid degradation.

The decrease in acid number was tested using CDI I compared to the abovementioned Stabaxol® I and Stabaxol® P 200 in the polyester polyol Desmophen® 2001 KS from Bayer MaterialScience AG.

For this purpose, at 80° C., 1% by weight of the abovementioned carbodiimides was stirred into polyester polyol having a measured acid number of about 0.9 mg KOH/g and the acid number was measured regularly.

The results are shown in Table 2:

| | Acid | Acid | Acid | Acid | Acide | Acid |
|---|---|---|---|---|---|---|
| | num- | num- | num- | num- | num- | num- |
| | ber | ber | ber | ber | ber | ber |
| | [mg | [mg | [mg | [mg | [mg | [mg |
| Carbodiimide | KOH | KOH | KOH | KOH | KOH | KOH |
| in | /g] | /g] | /g] | /g] | /g] | /g] |
| Desmophen ® | after | after | after | after | after | after |
| 2001 | 0 | 30 | 60 | 120 | 240 | 480 |
| KS | min | min | min | min | min | min |
| CDI I (inv.) | 0.86 | 0.51 | 0.27 | 0.09 | 0.00 | |
| Stabaxol ® I | 0.92 | 0.67 | 0.45 | 0.26 | 0.12 | 0.04 |
| (C) | | | | | | |
| Stabaxol ® P | 0.87 | 0.69 | 0.55 | 0.42 | 0.35 | 0.28 |
| 200 (C) | | | | | | |

C=comparative example, inv.=inventive

The results in tables 1 and 2 show that the method according to the invention, with the use of liquid monomeric carbodiimides, as well as great advantages in terms of handling, also leads to a very rapid decrease in acid number with simultaneously very good thermal stability.

What is claimed is:

1. A method for stabilizing polymers containing ester groups, characterized in that carbodiimides of the formula (I) 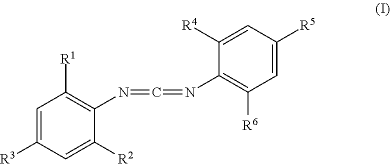
where R¹, R², R⁴ and R⁶ is each independently C₃-C₆-alkyl
and R³ and R⁵ is each independently C₁-C₃alkyl,
are added in liquid form (liquid-dosed) in continuous or batch wise processes for preparation and/or processing thereof.

2. The method as claimed in claim 1, characterized in that the R¹ to R⁶ radicals are the same within the molecule.

3. The method as claimed in claim 1 or 2, characterized in that the R¹ to R⁶ radicals are isopropyl.

4. The method as claimed in claim 1, characterized in that the liquid carbodiimide is added at temperatures of 10-35° C.

5. The method as claimed in claim 1, characterized in that the polymers are thermoplastic polyurethanes (TPU).
